(19) United States
(12) Patent Application Publication
(10) Pub. No.: US 2022/0088620 A1
(43) Pub. Date: Mar. 24, 2022

(54) MODULAR FLUID SPRAY NOZZLES AND RELATED SYSTEMS AND METHODS

(71) Applicant: Stephen D. Shoap, Wakefield, MA (US)

(72) Inventor: Stephen D. Shoap, Wakefield, MA (US)

(21) Appl. No.: 17/540,815

(22) Filed: Dec. 2, 2021

Related U.S. Application Data
(63) Continuation-in-part of application No. 17/127,182, filed on Dec. 18, 2020, now Pat. No. 11,203,023.
(60) Provisional application No. 62/974,727, filed on Dec. 20, 2019.

(51) Int. Cl. B05B 1/20; B05B 15/62; A62C 35/68

(52) U.S. Cl. CPC B05B 1/20; A62C 35/68; B05B 15/62

(57) ABSTRACT

A modular fluid spray nozzle is constructed from an inner conduit, having a sidewall with a center hole, housed inside a center conduit that includes a window defined by a sidewall, and a flexible or rigid outer conduit wrapped around the center conduit and forming a chamber with the rectangular window. The chamber is in fluid communication with the center hole and with at least two apertures defined by the outer conduit. The inner conduit is configured to be coupled to any type of conduit material, such as PVC pipe or another modular fluid hose segment.

### CROSS REFERENCE TO RELATED APPLICATION

This application is a Continuation in Part of U.S. patent application Ser. No. 17/127,182 filed Dec. 18, 2020, which claims the benefit of U.S. Provisional Application Ser. No. 62/974,727, entitled “A Standalone Spray Nozzle” filed Dec. 20, 2019, the entire disclosures of which are incorporated herein by reference.

### FIELD OF THE DISCLOSURE

The present disclosure is generally related to nozzles and more particularly is related to a fluid spray apparatus with modular nozzles and related systems and methods.

### BACKGROUND OF THE DISCLOSURE

Firefighters use hoses to spray water, or other fluids, onto fires in order to extinguish the fires. The water exits these hoses from a nozzle at the end of the hoses, which the firefighters can direct to an appropriate location. Non-structural fires, such as wildfires, bushfires, or grassfires, commonly have a wide front which is difficult to fight with conventional hoses. Fire fighters on the ground, or on fire trucks, can spray water onto only a small section of a wide area fire at any given moment, which may allow fires in other areas to increase. Sometimes, fire trucks can become surrounded and trapped by a fast-moving fire.

One method of stopping a grassfire or a wildfire is to create a fire break, a gap in vegetation or other combustible material that acts as a barrier to slow or stop the progress of a bushfire or wildfire. Fire breaks often have a size in the range of 10 feet wide and as long as deemed necessary, usually sufficiently long to prevent the fire from moving around the fire break. Most fire breaks are created by teams of firefighters with hand tools, which is highly labor intensive. Where possible, tractors and plows can be used to create the fire breaks, but many wildfire locations are not easily accessible. Furthermore, when using fire breaks, wildfires can quickly become large and difficult to control. Large fires create winds that blow burning embers through the air over long distances. A 10-foot fire break can be easily jumped by blowing embers, which subverts the intended purpose of the fire break.

Within the industry, some conventional devices are available to help prevent blowing embers moving past a fire break. One such device, called a water curtain, uses a conventional hose that has many simple holes that are placed close together along the length of the hose. As water is pumped through the hose, it exits each hole and is directed straight up in a vertical column. The resulting overall spray shape is that of a thin curtain, in that, the spraying water is positioned along the length of the hose, but it is only a very thin wall of water. These water curtains are rarely used because they are too thin to significantly reduce radiant heat from a fire, and because the available water is better used to wet the nearby fuels to prevent their ignition.

One technique to protect a structure, such as a building, from a wildfire is to deploy a defensive line of rotating sprinklers on tripods, and to supply these sprinklers with water using fire hoses. Setting up such a system can be very time consuming though, and the hardware required is expensive. Another technique to protect a structure is to place permanent sprinklers on the roofs or walls of the structures. This technique, unfortunately, allows the fire to get very close to the structure before encountering a spray of water or other fire resisting fluids, which subjects the structure to high temperatures from the encroaching fire. The radiant heat from a fire can be very intense and it is best to keep the fire farther away from the structure. Placing sprinklers on a structure is also not as effective as having a system located farther from the structure which can spray fluid to stop a wildfire. Thus, a heretofore unaddressed need exists in the industry to address the aforementioned deficiencies and inadequacies in current firefighting technologies.

### SUMMARY

The present disclosure, and embodiments described herein, is directed toward modular fluid spray nozzles and related devices and methods. The modular fluid spray nozzles are capable of being coupled to any type of conduit material, for example, PVC piping, segments of hose, or other types of fluid conduit segments. The modular design provides advantages over other designs in that the individual modular nozzles can be attached to mix of existing conduit material to provide a broader dispersal of water to desired areas. Additionally, the modular fluid spray nozzles can have variable spacings, such as being linked directly together, as well as connected to varying lengths of conduit, to create a wall of water with different flows as required by the local fuel load and different terrain. Moreover, adding additional units of the disclosed modular fluid spray nozzles to existing conduit material can allow for increased water dispersal in targeted areas, which can lead to less water usage and waste.

### BRIEF DESCRIPTION OF DRAWINGS

FIG. 1 is an illustration of a perspective view of components of an exemplary modular fluid spray nozzle configured in accordance with some embodiments of the subject disclosure.

FIG. 2A is an illustration of a perspective view of an inner conduit of the modular fluid spray nozzle illustrated in FIG. 1.

FIG. 2B is an illustration of a perspective side view of the inner conduit of FIG. 2A with notches for hose connections on each end of the inner conduit.

FIG. 3 is an illustration of a perspective view of a center conduit of the modular fluid spray nozzle illustrated in FIG. 1.

FIG. 4 is an illustration of a perspective view of an outer conduit of the modular fluid spray nozzle illustrated in FIG. 1.

FIG. 5 is an illustration of a cut-away perspective side view of the modular fluid spray nozzle illustrated in FIG. 1 with representations of fluid flow.

FIG. 6 shows a cross-sectional front view of complete the modular fluid spray nozzle illustrated in FIG. 1 with representations of fluid flow.

FIG. 7A shows an oblique view of a conduit spraying a stream of fluid from a single hole.

FIG. 7B is a schematic illustration of an array of modular fluid spray nozzles connected to a pump and a water source.

FIG. 7C is a representative illustration of one possible embodiment of modular fluid spray nozzles connected directly together.

FIG. 8 is an illustration of a perspective view of a lawn sprinkler as is known in the prior art.

FIG. 9A is an illustration of a topology for an array of conventional sprinklers.

FIG. 9B is an illustration of the topology of the array of conventional sprinklers illustrated in FIG. 9A with the addition of embers permeating the array.

FIG. 10 is an illustration of an exploded view of an alternative conduit combination illustrated in FIG. 1, in accordance with a second exemplary embodiment of the invention.

FIG. 11 is an illustration of an exploded view of an alternative conduit combination illustrated in FIG. 1, in accordance with a third exemplary embodiment of the invention.

FIG. 12 is a perspective view of view of components of an exemplary modular fluid spray nozzle configured in accordance with a fourth exemplary embodiment of the invention.

FIG. 13 is an illustration of a cut-away perspective side view of a modular fluid spray nozzle in accordance with a fifth exemplary embodiment of the invention.

FIG. 14 is an illustration of an exploded view of an alternative conduit combination illustrated in FIG. 1, in accordance with a sixth exemplary embodiment of the invention.

FIG. 15 is an illustration of an exploded view of an alternative conduit combination illustrated in FIG. 1, in accordance with a seventh exemplary embodiment of the invention.

### DETAILED DESCRIPTION

The present disclosure and figures are directed toward modular fluid spray nozzles and related systems and methods. The modular fluid spray nozzles are capable of being coupled to conduit materials, such as existing piping or hosing, or coupled to one another. The modular fluid spray nozzle can be used to protect structures from a heat source, such as a fire, through a targeted application of water to a desired area. The modular fluid spray nozzle can be attached to piping along a roof of a house to more adequately protect the house from a fire. In other embodiments, the modular fluid spray nozzles can be deployed farther away from a house or other structure to keep the fire and its heat from coming too close to the structure. The modular fluid spray nozzles each include at least two nozzles which cause the water to exit the nozzles in a highly dispersed, uniform manner. The presently disclosed devices and methods of delivering water can utilize less water while still providing sufficient amounts of fluid to a desired area. The modular fluid spray nozzles contain no moving parts, are fast and easy to deploy, and provide an extremely low cost way to protect structures or other objects from a fire.

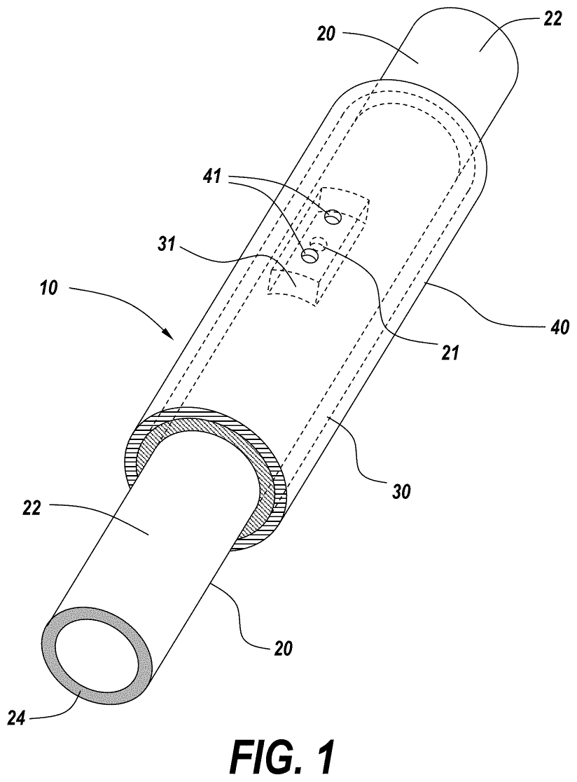

FIG. 1 is an illustration of a perspective view of components that form a modular fluid spray nozzle 10 configured in accordance with the subject disclosure. In particular, FIG. 1 is an illustration of an inner hollow cylinder 20, a center hollow cylinder 30, and an outer hollow cylinder 40. When the modular fluid spray nozzle 10 is assembled, the inner hollow cylinder 20 is housed inside of, and preferably adhered to, the center hollow cylinder 30. The inner hollow cylinder 20 is sized to be a tight fit inside the center hollow cylinder 30 in the vicinity of the window 31.

When fully assembled, the outer hollow cylinder 40 is preferably sized to be a tight fit to center hollow cylinder 30, and is preferably adhered to the center hollow cylinder 30. Outer hollow cylinder 40 can be replaced by a small segment of comparable material that extends across the window 31.

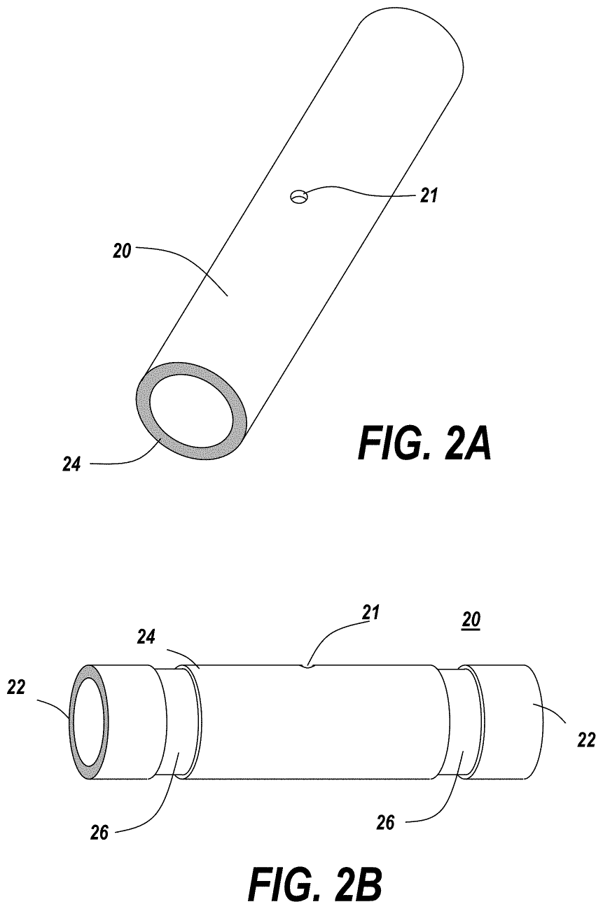

As shown in FIG. 2A, inner hollow cylinder 20 has an overall cylindrical shape defined by a sidewall 24 that includes a hole 21.

As shown in FIG. 1, inner hollow cylinder 20 has ends 22 that extend beyond the length of center hollow cylinder 30. In some embodiments, ends 22 may be configured to couple to different types of conduit material. For example, in some embodiments, ends 22 can be configured to be coupled to a hose. This possible embodiment is supported by FIG. 2B, which shows notches 26 on each end 22 of inner hollow cylinder 20. A hose clamp forces a hose into the notches 26 to secure the hose to inner hollow cylinder 20. The ends 22 can also be glued or adhesively bonded to PVC pipe. Ends 22 can be configured to be coupled to another modular fluid spray nozzle 10. While FIG. 2B illustrates one possible construction of the inner hollow cylinder 20 to enable conduit connection to the ends 22, those having skill in the art will recognize other construction of the ends 22 to enable connection to other conduit can be adopted without departing from the scope of the present invention.

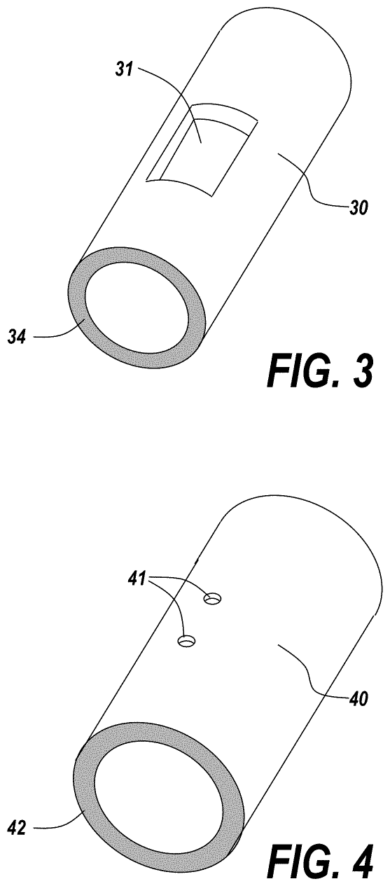

As shown in FIG. 3, center hollow cylinder 30 includes a sidewall 34 with a window 31. Window 31 is an aperture that extends through sidewall 34. As shown in FIG. 3, window 31 is shown with a rectangular shape, but in other embodiments, window 31 may be shaped as an oval, trapezoid, or possess a different geometry. When inner hollow cylinder 20 is mated with center hollow cylinder 30, the hole 21 in inner hollow cylinder 20 is placed so as to be aligned with the window 31 of center hollow cylinder 30.

FIG. 4 shows the outer hollow cylinder 40 with two apertures 41 in its sidewall 42. Outer hollow conduit 40 can be made from fire resistant hose which will give protection from heat and flames to the modular fluid spray nozzle 10. The fire-resistant hose will maintain its integrity for at least thirty minutes while within twenty feet of an open fire. Studies have shown that wildfires travel quickly through neighborhoods. There are many examples of homes that have escaped destruction because the homeowner has turned on a lawn sprinkler system which wet the ground next to the home. It is expected that the spray from the modular spray nozzles will be better than a lawn sprinkler because the modular spray nozzles shoot the water or foam higher into the air, and higher onto the house. With the fire kept at bay during a wildfire, it will pass before structural integrity of the hose is compromised. The outer hollow conduit 40 may be made from a ceramic or ceramic infused material or a ceramifiable rubber. The outer hollow conduit 40 may be made from an extruded nitrile rubber hose commercially available from Snaptite Corporation, or something structurally equivalent. The outer hollow conduit 40 may include a woven reinforcement jacket with thermoplastic polyurethane extruded into the weave of the woven reinforcement jacket.

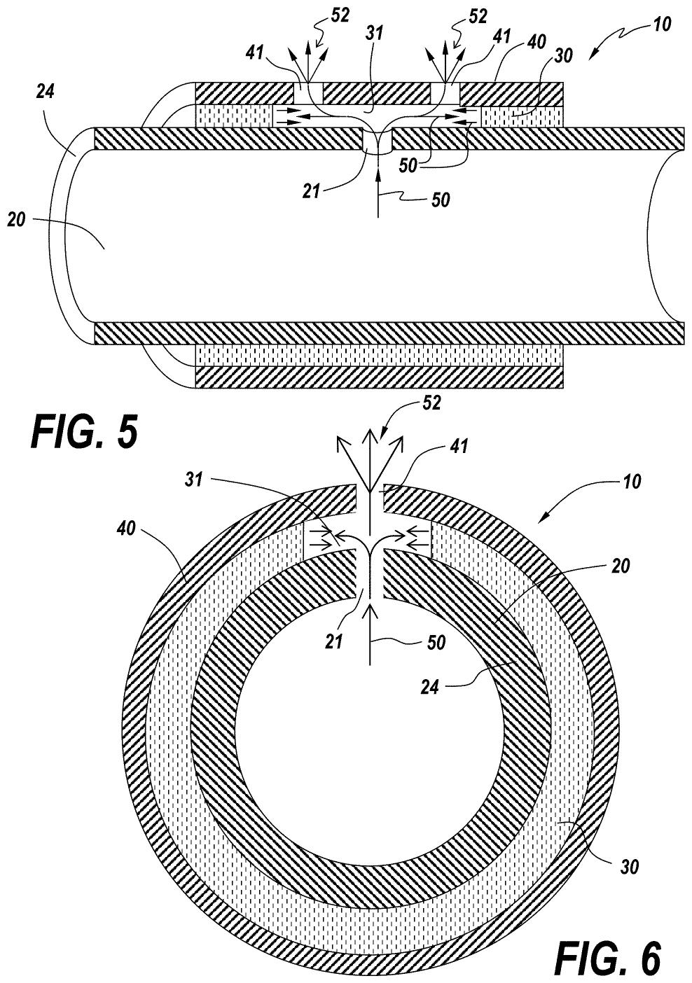

FIG. 5 is an illustration of a cut-away perspective side view of the modular fluid spray nozzle illustrated in FIG. 1 with representations of fluid flow. FIG. 6 shows a cross-sectional front view of complete the modular fluid spray nozzle illustrated in FIG. 1 with representations of fluid flow. FIG. 5 and FIG. 6 shows how window 31 from FIG. 3 is bordered with the inner and outer hollow conduits 20, 40 to form a chamber where the liquid flows acquire their unique rectangular spray shape. FIG. 5 shows a cut away view of the assembly of hollow conduits 20, 30, and 40. Some fluid flows from the inside of inner hollow cylinder 20 along flow path 50 and through the hole 21. Since apertures 41, shown in FIG. 5, are axially misaligned with the hole 21, flow path 50 is forced to oscillate inside the window 31. Eventually, the flow path 50 exits apertures 41. A flow pattern 52 has momentum components parallel to the through flow path 50 in inner hollow cylinder 20 when exiting apertures 41.

FIG. 6 is a cross sectional view looking into the inner hollow cylinder 20. FIG. 6 shows that the flow path 50 eventually exits apertures 41 as flow pattern 52. Flow pattern 52 has momentum components perpendicular to the through flow direction in inner hollow cylinder 20 when exiting apertures 41. The result of the parallel and perpendicular momentum components is a rectangular flow pattern 52 that comes out of apertures 41. This flow pattern 52 is very unusual and also very useful.

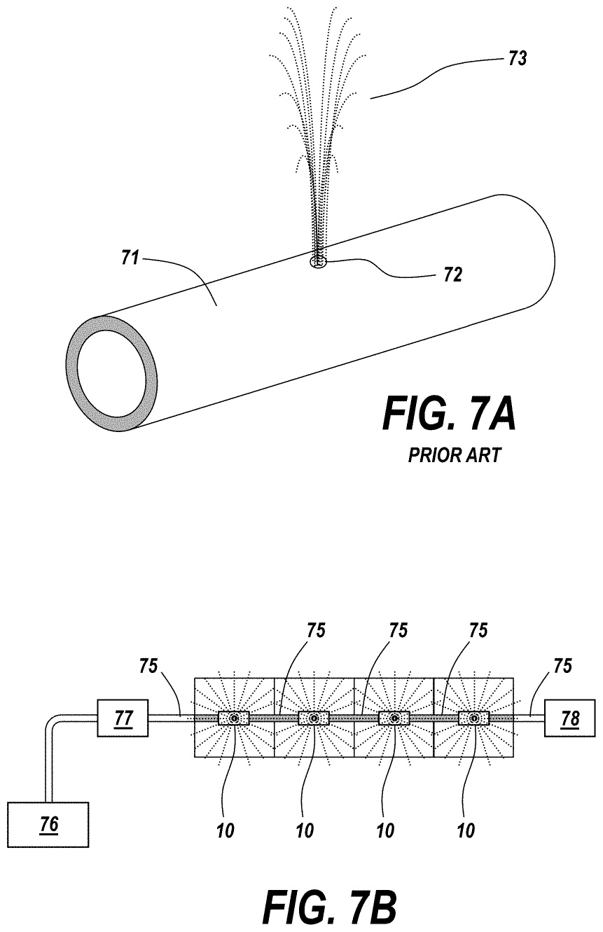

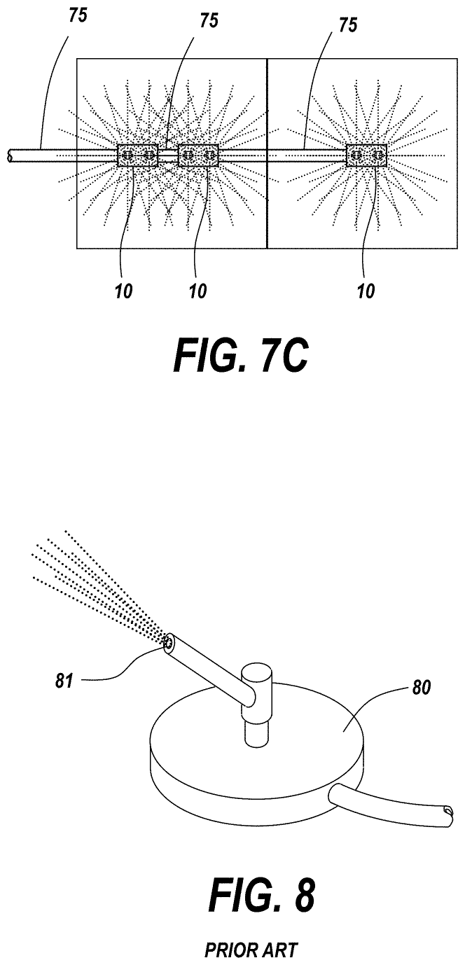

FIG. 7A show a conduit 71 with a single hole 72 spraying a narrow stream of fluid 73 out of the hole 72, as is known in the prior art. The stream 73 will rise very high, but being very narrow, it is not useful for fighting wildfires. Single holes 73 must be placed very close together to get a continuous wall of fluid. Many such holes require too much water to supply from a home or from a tanker truck.

FIG. 7B illustrates an array of modular fluid spray nozzles 10 connected together by approximately identical lengths of a conduit 75 formed from a rigid or flexible material. As used herein, rigid conduit is understood to be a PVC conduit or a conduit with rigidity characteristics comparable to commercially available PVC conduit. A flexible material is understood to be a rubber material or a rubber material infused, extruded, or bonded with a more heat resistant material such as a ceramic material or a thermoplastic polyurethane. A rigid conduit is the type of material that requires installation of an elbow or formation of an elbow to redirect the path of the conduit whereas a flexible conduit is bendable to materially alter the direction of the conduit. Different layers of conduit can be attached by glue, rivets, stitching, laser welding, fasteners, or other means known to those having ordinary skill in the art.

The modular fluid spray nozzles 10 have spray patterns 52 that are superior to the hole 72 in FIG. 7A. The conduit 75 could be PVC piping or flexible hose. Hoses may be secured to the inner hollow cylinder 20 with a hose clamp when a notch 26 is placed in each end 22 of the inner hollow cylinder 20. Flexible hoses may be connected to the ends 22 by other means as well. PVC conduit can be secured to PVC ends of the modular nozzle by various type of glue. Numerous other configurations and variations are possible. A pump 77 takes water from a fluid source 76, and forces the fluid into the modular fluid hose nozzles 10. At the end of the array of modular fluid spray nozzles 10, an end cap 78 stops the flow of fluid. If the end of the array did not have an end cap 78, then most of the fluid would flow out of the end of the array, and it would be wasted. When the modular fluid hose nozzles 10 are connected together by approximately identical lengths of conduit 75, the rate of fluid flow is quite constant along the array of modular fluid hose nozzles 10. The modular fluid hose nozzles 10 are quite insensitive to pressure drop along the many lengths of conduit 75. This means that the flow rate of fluid out of a modular fluid hose nozzle 10 is quite insensitive to its location in the array. FIG. 7B shows that each modular fluid hose nozzle 10 sprays a uniform, and almost equal, amount of fluid in a large rectangular area which is centered on its corresponding modular fluid hose nozzle 10.

FIG. 7C shows that the modular fluid hose nozzles 10 can be connected to each other as well as to a hose or PVC. The modular fluid hose nozzles 10 can have variable spacing that can be decided in the field. In FIG. 7C, the two modular fluid hose nozzles 10 10 on the left are grouped into a closely spaced pair. They can be connected together by a short hose or a PVC connector. The left pair will deliver twice as much water as the single modular fluid hose nozzle 10 on the right, to the same area on the ground. Thus, a protective water barrier can be custom created very quickly in the field such that more vulnerable areas can have more water sprayed on them. The presently disclosed modular fluid spray nozzles 10 provide numerous advantages over previous firefighting devices.

Another method of changing the amount of water that comes out of the modular fluid hose spray nozzle 10 is to change the size of the apertures 41 as shown in FIG. 4. The rectangular area that is wet by a modular fluid hose nozzle 10 is a function of the pressure of the fluid. The higher the pressure, the larger the area sprayed.

An array of modular fluid hose nozzles 10 does not have a significant problem with pressure drop due to friction losses in the hose or conduit. Modular fluid hose nozzles 10 that are farther from the water source have less water flowing through them. This difference is because earlier modules have taken water from the array and sprayed the water. Pressure loss from friction loss in the hose is a function of water flow. The farther modules get less water flow and therefore have less pressure loss per segment.

The disclosed modular fluid spray nozzles 10 can be constructed from relatively inexpensive materials. The disclosed modular fluid spray nozzles 10 provide a low cost alternative for homeowners to protect their homes and other structures from fires. The wide rectangular shape of the spray from modular fluid spray nozzles 10 enables the modular fluid spray nozzles 10 to be spaced many feet apart while still supplying a sufficient amount of water along the array.

FIG. 8 shows a conventional lawn sprinkler 80 that can rotate through 360 degrees or less as is known in the prior art. These types of sprinklers are offered by many companies as a means of protecting a structure.

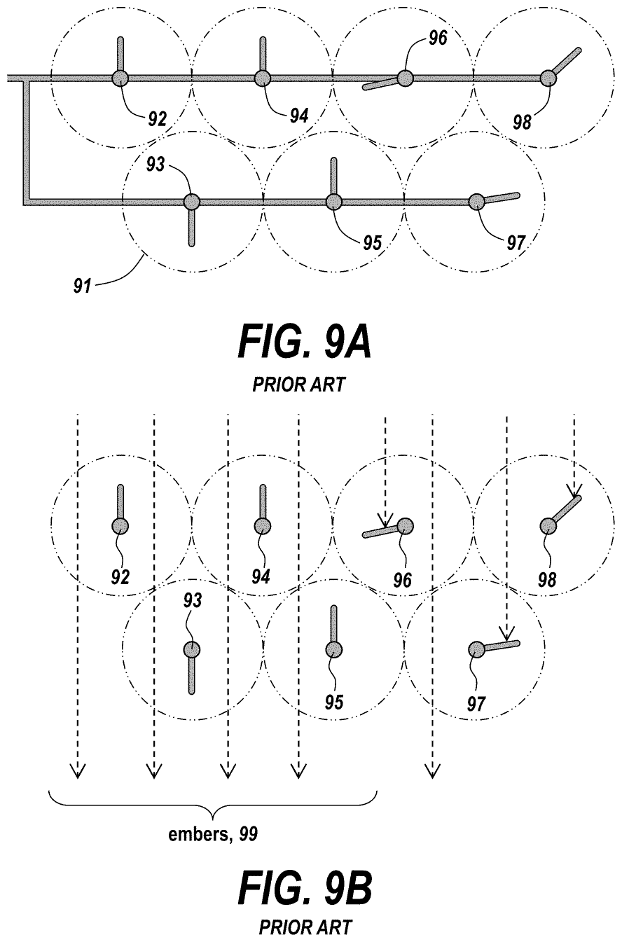

FIG. 9A shows the recommended topology for placement of a group of sprinklers when trying to stop a fire as is known in the prior art. Two rows of sprinklers are needed for the best fluid delivery from an array of sprinklers. Sprinklers 92-98 are shown in FIG. 9A. The circles 91 enclose the areas that have fluid delivered to them. FIG. 9B shows that a prior art sprinkler system cannot reliably prevent flying embers from passing the line of sprinklers. Flying embers are a major cause of homes catching fire. Sprinkler 92 is shown spraying upward. If sprinkler 93 is spraying downward, and Sprinklers 94 and 95 are spraying upwards at the same time, the flying burning embers 99 can get past the left half of the array of sprinklers. The sprinklers cannot be synchronized, and even if they could be synced with each other, there will always be times that embers can blow through sections of the sprinkler array. Compare FIG. 9B to FIG. 7B, which does not provide any gaps in protection.

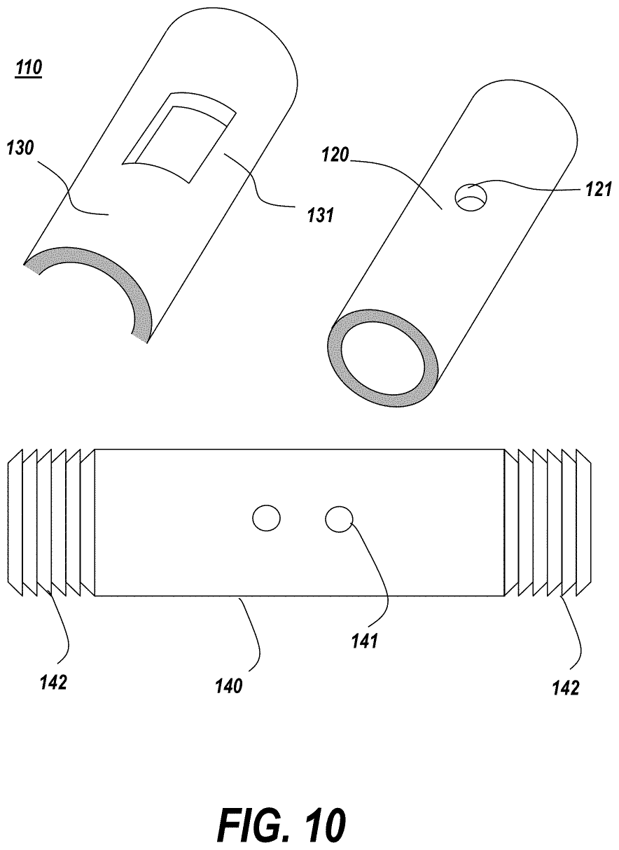

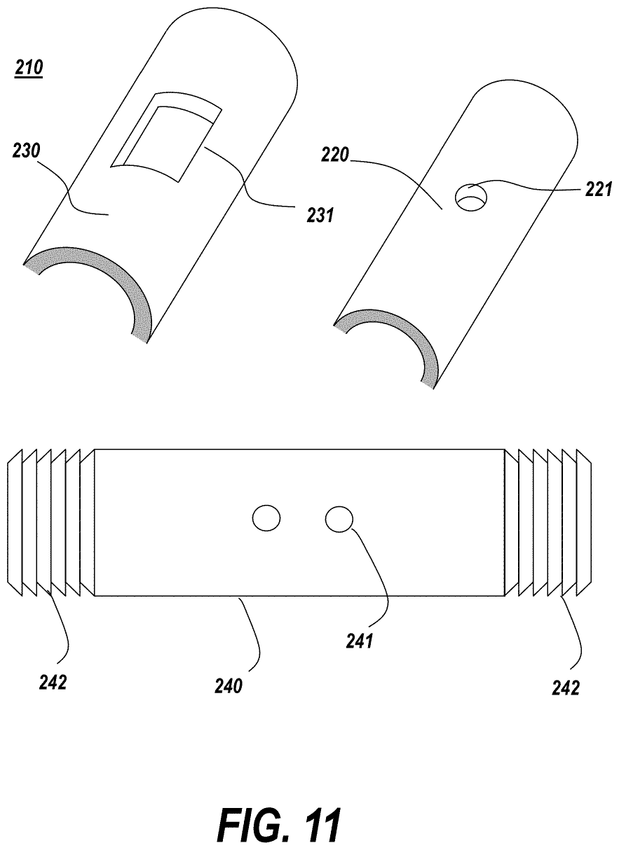

FIG. 10 illustrates an exploded view of a combination conduit 110, in accordance with a second exemplary embodiment of the invention. The combination conduit 110 includes a center sidewall 130 featuring a window 131. Unlike the illustration of the first embodiment, the center sidewall 130 is not a cylinder. The combination conduit includes an inner sidewall 120 with a single hole 121. The inner sidewall 120 may be a hollow conduit, as illustrated in FIG. 11, or a patch similar to the center sidewall 130. The outer sidewall 140 includes two apertures 141. When assembled, the apertures 141, window 131, and hole 121 align similar to the arrangement illustrated in FIG. 5, creating a chamber. Fluid under pressure enters the chamber through the hole 121 and the fluid oscillates inside the chamber. This oscillation creates the desired spray coming out of the apertures 141. At the ends of the combination conduit 110 are hose gripping barbs 142, which are used with hose clamps to securely attach hoses to the ends of the combination conduit 110. The notches 26 of FIG. 2 can also be used to secure the hoses.

FIG. 11 illustrates an exploded view of a combination conduit 210, in accordance with a second exemplary embodiment of the invention. The combination conduit 210 includes a center sidewall 230 featuring a window 231. The combination conduit includes an inner sidewall 220 with a single hole 221. The inner sidewall 220 may be a patch similar to the center sidewall 230. The outer sidewall 240 is a hollow conduit that includes two apertures 241. When assembled, the apertures 241, window 231, and hole 221 align similar to the arrangement illustrated in FIG. 5, creating a chamber. Fluid under pressure enters the chamber through the hole 221 and the fluid oscillates inside the chamber. This oscillation creates the desired spray coming out of the apertures 241. At the ends of the combination conduit 210 are hose gripping barbs 242, which are used with hose clamps to securely attach hoses to the ends of the combination conduit 210. The notches 26 of FIG. 2 can also be used to secure the hoses.

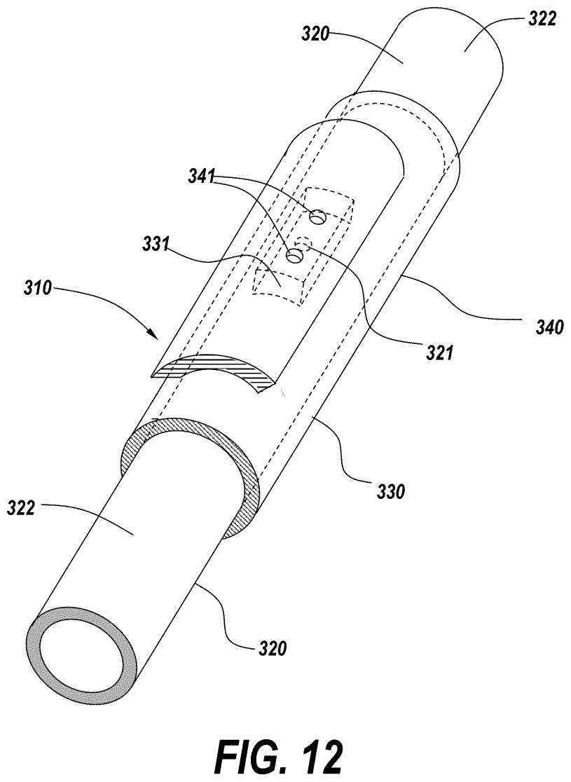

FIG. 12 is a perspective view of view of a combination conduit 310 of an exemplary modular fluid spray nozzle configured in accordance with a fourth exemplary embodiment of the invention. The combination conduit 310 includes a center sidewall 330 featuring a window 331. In this embodiment, the center sidewall 330 is a conduit. The combination conduit 310 includes an inner sidewall 320 with a single hole 321 and ends 322. The inner sidewall 320 is a conduit in this embodiment. The outer sidewall 340 is a patch that includes two apertures 341. When assembled, the apertures 341, window 331, and hole 321 align similar to the arrangement illustrated in FIG. 5, creating a chamber. Fluid under pressure enters the chamber through the hole 321 and the fluid oscillates inside the chamber. This oscillation creates the desired spray coming out of the apertures 341. At the ends of the combination conduit 310, and more specifically the inner sidewall 320, may be hose gripping barbs, notches, or other connections systems used with hose clamps to securely attach hoses to the ends of the combination conduit 310.

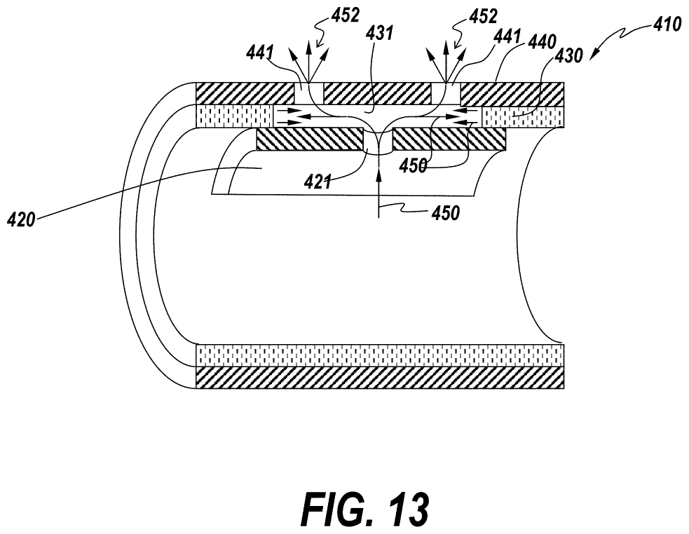

FIG. 13 is an illustration of a cut-away perspective side view of a combination conduit 410 of an exemplary modular fluid spray nozzle configured in accordance with a fifth exemplary embodiment of the invention. The combination conduit 410 includes a center sidewall 430 featuring a window 431. In this embodiment, the center sidewall 430 is a conduit. The combination conduit 410 includes an inner sidewall 420 with a single hole 421. The inner sidewall 420 is a patch in this embodiment rather than a conduit. The outer sidewall 440 is a conduit that includes two apertures 441. When assembled, the apertures 441, window 431, and hole 421 align similar to the arrangement illustrated in FIG. 5, creating a chamber. Fluid under pressure enters the chamber along a flowpath 450 through the hole 421 and the fluid oscillates inside the chamber. This oscillation creates the desired spray 452 coming out of the apertures 441. At the ends of the combination conduit 410, and more specifically the inner sidewall 420, may be hose gripping barbs, notches, or other connections systems used with hose clamps to securely attach hoses to the ends of the combination conduit 410.

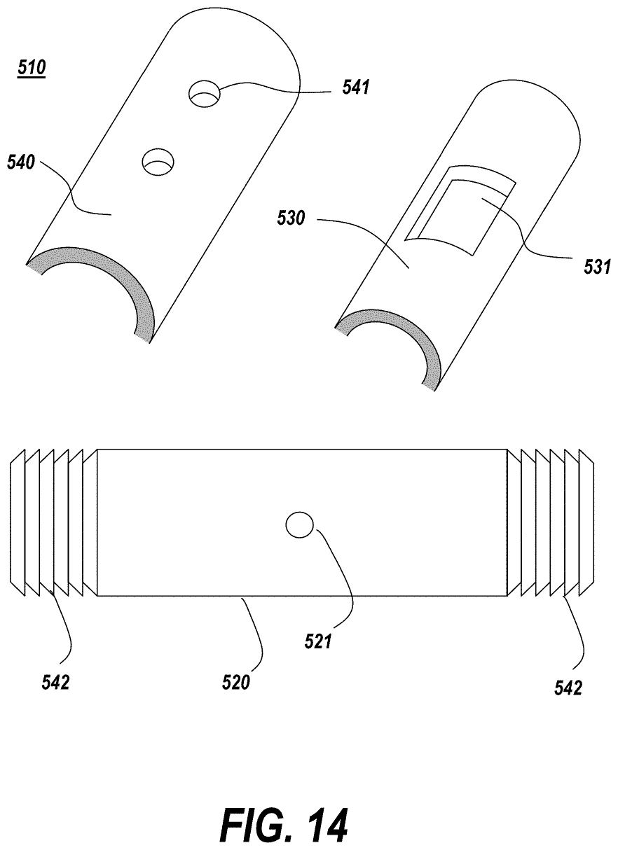

FIG. 14 is an illustrates an exploded view of a combination conduit 510, in accordance with a sixth exemplary embodiment of the invention. The combination conduit 510 includes a center sidewall 530 featuring a window 531. The combination conduit includes an inner sidewall 520 with a single hole 521 and two ends with hose gripping barbs 542. The inner sidewall 520 is a conduit. The outer sidewall 540 is a patch, similar to the center sidewall 530, that includes two apertures 541. When assembled, the apertures 541, window 531, and hole 521 align similar to the arrangement illustrated in FIG. 5, creating a chamber. Fluid under pressure enters the chamber through the hole 521 and the fluid oscillates inside the chamber. This oscillation creates the desired spray coming out of the apertures 541. At the ends of the combination conduit 510 are hose gripping barbs 542, which are used with hose clamps to securely attach hoses to the ends of the combination conduit 510. The notches 26 of FIG. 2 can also be used to secure the hoses.

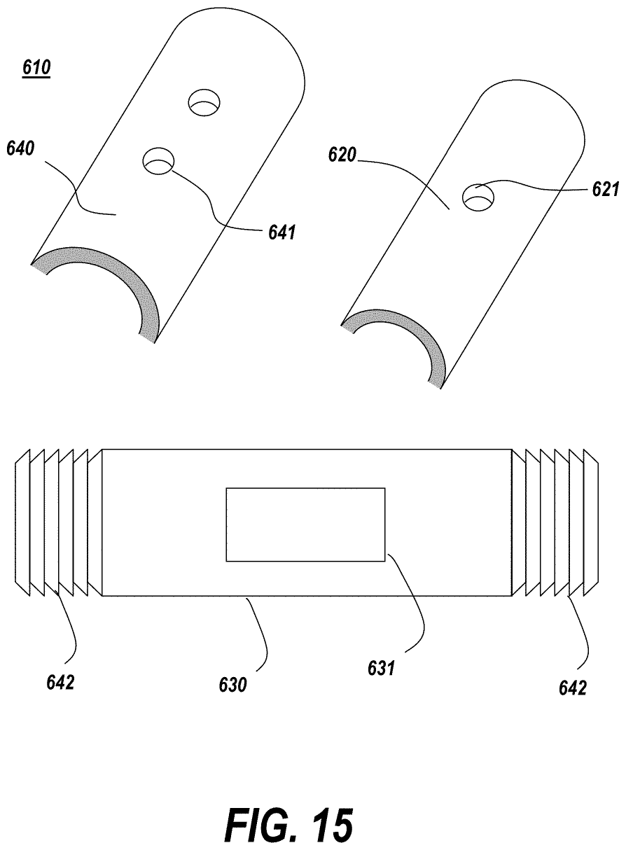

FIG. 15 is an illustrates an exploded view of a combination conduit 610, in accordance with a seventh exemplary embodiment of the invention. The combination conduit 610 includes a center sidewall 630, which is a conduit in this embodiment, featuring a window 631 and two ends with hose gripping barbs 642. The combination conduit includes an inner sidewall 620 with a single hole 621. The inner sidewall 620 is a patch. The outer sidewall 640 is a patch, similar to the inner sidewall 620, that includes two apertures 641. When assembled, the apertures 641, window 631, and hole 621 align similar to the arrangement illustrated in FIG. 5, creating a chamber. Fluid under pressure enters the chamber through the hole 621 and the fluid oscillates inside the chamber. This oscillation creates the desired spray coming out of the apertures 641. At the ends of the combination conduit 610 are hose gripping barbs 642, which are used with hose clamps to securely attach hoses to the ends of the combination conduit 610. The notches 26 of FIG. 2 can also be used to secure the hoses.

As will be understood by one having ordinary skill in the art, there are several different techniques that may be adopted to form the chamber illustrated in FIGS. 5 and 6 and each of these techniques is within the scope of the present disclosure.

What is claimed is:

1. A conduit spray system for fluids, the system comprising:
a nozzle assembly having two ends, the nozzle comprising:
an inner sidewall having at least one hole;
a center sidewall fixed to the inner sidewall and a window formed through the center sidewall, wherein the window is aligned with the at least one hole; and
an outer sidewall fixed to the center sidewall, wherein the outer sidewall has at least two apertures aligned with the window, wherein a portion of an inner surface of the outer sidewall, center sidewall forming the window, and an outer surface of the inner sidewall define a chamber that is in fluid communication with the at least one hole,
wherein the at least two ends are formed from one of the sidewalls.

2. The system of claim 1, wherein the at least two apertures are axially offset from at least one hole in the inner sidewall.

3. The system of claim 1, wherein at least one of the sidewalls is constructed from PVC or other rigid conduit materials.

4. The system of claim 1, wherein at least one of the sidewalls is constructed from a flexible material.

5. The system of claim 1, wherein at least one of the sidewalls is constructed from a fire-resistant material.

6. The system of claim 1, wherein at least one of the sidewalls further comprises a hollow cylinder having the two ends.

7. The system of claim 1, wherein one or both of the two ends is coupled to another modular fluid spray nozzle, whereby the flow from the coupled nozzles is proportionally increased in the surrounding area.

8. The system of claim 1, wherein one of the two ends is coupled to a flexible hollow cylinder.

9. The system of claim 1, wherein one of the two ends is coupled to a rigid hollow cylinder.

10. The system of claim 6, further comprising foam and water flowing within the hollow cylinder.

11. The system of claim 1, further comprising a mechanical fastening structure on each of the ends, thereby facilitating connecting the ends to a hose or a conduit.

13. The system of claim 1, wherein at least one of the sidewalls does not form a hollow cylinder.
